(19) United States
(12) Patent Application Publication
(10) Pub. No.: US 2024/0107296 A1
(43) Pub. Date: Mar. 28, 2024

(54) METHOD AND DEVICE FOR WIRELESS COMMUNICATION

(71) Applicants: Yu CHEN, SHANGHAI (CN); Xiaobo ZHANG, Shanghai (CN)

(72) Inventors: Yu CHEN, SHANGHAI (CN); Xiaobo ZHANG, Shanghai (CN)

(73) Assignee: SHANGHAI LANGBO COMMUNICATION TECHNOLOGY COMPANY LIMITED, SHANGHAI, OT (CN)

(21) Appl. No.: 18/368,570

(22) Filed: Sep. 15, 2023

(30) Foreign Application Priority Data
Sep. 28, 2022 (CN) 202211192219.7

(51) Int. Cl. H04W 12/04; H04L 45/74

(52) U.S. Cl. CPC H04W 12/04; H04L 45/74; H04W 92/18

(57) ABSTRACT

Discloser a method and a device for wireless communications, including: transmitting a first MAC PDU, the first MAC PDU comprising a first MAC header and a first MAC subPDU, the first MAC subPDU comprising a first MAC sub-header and a first MAC SDU, the first MAC SDU comprising a first PDCP PDU; the first PDCP PDU being a PDCP PDU of a sidelink RB; herein, a target parameter is used for security algorithm of the first PDCP PDU; whether the target parameter is a LCID is related to whether the first node is a generator of the first PDCP PDU; when the first node is the generator of the first PDCP PDU, the target parameter is a LCID; when the first node is not the generator of the first PDCP PDU, the target parameter is not a LCID. The present application can better ensure security using a target parameter.

### CROSS REFERENCE TO RELATED APPLICATIONS

This application claims the priority benefit of Chinese Patent Application No. 202211192219.7, filed on Sep. 28, 2022, the full disclosure of which is incorporated herein by reference.

### BACKGROUND

### Technical Field

The present application relates to transmission methods and devices in wireless communication systems, and in particular to that relating to the security in wireless communications, sidelink communications and relay communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LIE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non Terrestrial Network (NTN) and Terrestrial Network (TN), Dual connectivity system, or combined, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE's connection with the network can be achieved directly or by relaying.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

Refer to 3GPP specifications for the concepts, terminology and abbreviations given in the present application, including but not limited to:
https://www.3gpp.org/ftp/Specs/archive/21_series/21.905/21905-h10.zip
https://www.3gpp.org/ftp/Specs/archive/38_series/38.300/38300-h10.zip
https://www.3gpp.org/ftp/Specs/archive/38_series/38.331/38331-h10.zip
https://www.3gpp.org/ftp/Specs/archive/38_series/38.321/38321-h10.zip https://www.3gpp.org/ftp/Specs/archive/38_series/38.304/38304-h10.zip
https://www.3gpp.org/ftp/Specs/archive/23_series/23.287/23287-h10.zip https://www.3gpp.org/ftp/Specs/archive/23_series/23.304/23304-h10.zip

### SUMMARY

In multiple communication scenarios, especially during communications between one User Equipment (UE) and another, issues such as control, the link establishment, parameter configuration and resource allocation shall be considered. Due to the lack of a central control node like a serving cell, communications between UEs, particularly inter-UE communications with a relay node, will be confronted with the problem of distributed control, and if configured improperly, it will cause mismatch, which in turn will lead to communication failure. Among all kinds of configurations, the configuration relating to security is most important, which, if configured incorrectly, will inevitably lead to that the receiving end fails to receive correctly. Security algorithm relies on some input parameters. In sidelink communications, a logical channel identity (LCID) can be used as an input parameter of the security algorithm, which is easy to operate and practicable in UE-UE communications without relay. But in a scenario where a UE is in communication with another UE via relay, there are 2 links connected by a relay node, i.e., 2 hops that may use different logical channels, which means that if a local parameter is used in the UE-to-UE (or, peer-to-peer) security algorithm, different input parameters will be used for transmission and reception, making it impossible to decipher. Hence, there arise a key issue as to how to determine parameters input to security algorithm in UE-to-UE communications, particularly when relating to relay.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Besides, the method proposed in the present application can also be used for addressing other issues confronting communications.

The present application provides a method in a first node for wireless communications, comprising:
transmitting a first MAC PDU, the first MAC PDU comprising a first MAC header and a first MAC subPDU, the first MAC subPDU comprising a first MAC sub-header and a first MAC SDU, the first MAC SDU comprising a first PDCP PDU; the first PDCP PDU being a PDCP PDU of a unicast sidelink RB;
herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU.

In one embodiment, a problem to be solved in the present application includes: how to determine parameters of corresponding security algorithms according to specific conditions; how to support security in sidelink communications, and how to support security in relay communications, especially in UE-UE relay communications; how to ensure the continuity of traffics, and how to reduce the complexity of security algorithm, and how to support security of mixed scenarios.

In one embodiment, an advantage of the above method includes: Providing support to security of different scenarios in sidelink communications, security in relay communications, and security of UE-UE communications, as well as support to the traffic continuity and the multiplexing of traffics, and reducing the complexity of communications, ensuring the communication quality, improving user experience and avoiding the interruption of communication.

Specifically, according to one aspect of the present application, a second MAC PDU is received before the action of transmitting a first MAC PDU, the second MAC PDU for generating the first MAC PDU; herein, the second MAC PDU comprises a second MAC header and a second MAC subPDU, the second MAC subPDU comprising a second MAC subheader and a second MAC SDU, the second MAC SDU comprising the first PDCP PDU; the generator of the first PDCP PDU is a node other than the first node.

Specifically, according to one aspect of the present application, the second MAC header comprises a first field and a second field, where the first field in the second MAC header indicates the generator of the first PDCP PDU, while the second field in the second MAC header indicates the first node; the first MAC header comprises a first field and a second field, where the first field comprised by the first MAC header indicates the first node, while the second field comprised by the first MAC header indicates a receiver of the first MAC PDU.

Specifically, according to one aspect of the present application, the first MAC SDU comprises a PDU of a first protocol layer, the first protocol layer being a protocol layer between an RLC layer and a PDCP layer, with a header of the PDU of the first protocol layer comprising the target parameter; herein, the generator of the first PDCP PDU is a node other than the first node.

Specifically, according to one aspect of the present application, the target parameter is a state variable of a second protocol layer, the second protocol layer being one of a MAC layer, a Radio Link Control (RLC) layer, a PDCP layer or a first protocol layer; herein, the first protocol layer is a protocol layer between the RLC layer and the PDCP layer.

Specifically, according to one aspect of the present application, the target parameter identifies a link or a node.

Specifically, according to one aspect of the present application, a third MAC PDU is transmitted, the third MAC PDU comprising a third MAC header and a third MAC subPDU, the third MAC subPDU comprising a third MAC subheader and a third MAC SDU, the third MAC SDU comprising a first signaling, the first signaling used for indicating the target parameter; herein, the third MAC header comprises a first field and a second field, where the first field in the third MAC header indicates the first node, while the second field in the third MAC header indicates one of a generator of the first PDCP PDU or a receiver of the first MAC PDU.

Specifically, according to one aspect of the present application, a fourth MAC PDU is received; the fourth MAC PDU comprises a fourth MAC header and a fourth MAC subPDU, the fourth MAC subPCU comprising a fourth MAC subheader and a fourth MAC SDU, the fourth MAC SDU comprising a second PDCP PDU; the second PDCP PDU being a PDCP PDU of a unicast sidelink RB; the target parameter is used for security algorithm of the second PDCP PDU;
herein, the fourth MAC header comprises a first field and a second field, where the first field in the fourth MAC header indicates a receiver of the first MAC PDU; while the second field in the fourth MAC header indicates the first node.

Specifically, according to one aspect of the present application, a change of the target parameter is used for triggering re-establishment of a PDCP entity for generating the first PDCP PDU.

Specifically, according to one aspect of the present application, the first node is a terminal of Internet of Things (IoT).

Specifically, according to one aspect of the present application, the first node is a UE.

Specifically, according to one aspect of the present application, the first node is a relay.

Specifically, according to one aspect of the present application, the first node is an access-network device.

Specifically, according to one aspect of the present application, the first node is a vehicle-mounted terminal.

Specifically, according to one aspect of the present application, the first node is an aircraft.

Specifically, according to one aspect of the present application, the first node is a cellphone.

The present application provides a first node for wireless communications, comprising:
a first transmitter, transmitting a first Medium Access Control (MAC) Protocol Data Unit (PDU), the first MAC PDU comprising a first MAC header and a first MAC subPDU, the first MAC subPDU comprising a first MAC sub-header and a first MAC Service Data Unit (SDU), the first MAC SDU comprising a first Packet Data Convergence Protocol (PDCP) PDU; the first PDCP PDU being a PDCP PDU of a unicast sidelink RB;
herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU.

In one embodiment, compared with the prior art, the present application is advantageous in the following aspects:

It supports the security when using relay in UE-UE communication, besides, a relay node can exist both as a relay and a remote node.

It supports traffic continuity, namely, even if the relay is changed, it can still ensure continuous running of the security algorithm, which helps shorten the delay incurred during the change of delay.

It is multi-hop-supporting, so when using multiple relays, namely when there are over 2 hops, no extra complexity will be seen, nor will the effectiveness of the method in the present application be affected.

It can determine the input to security algorithm when establishing a PC5 unicast connection without being coordinated by the relay, which is faster and causes a shorter delay.

It is applicable to L2 U2U relay communications.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmitting a first MAC PDU according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to one embodiment of the present application.

FIG. 7 illustrates a schematic diagram of a first protocol layer PDU according to one embodiment of the present application.

FIG. 8 illustrates a schematic diagram of a MAC PDU according to one embodiment of the present application.

FIG. 9 illustrates a schematic diagram of protocol stack according to one embodiment of the present application.

FIG. 10 illustrates a schematic diagram showing a first key used for security algorithm of a first PD CP PDU according to one embodiment of the present application.

FIG. 11 illustrates a structure block diagram of a processing device in a first node according to one embodiment of the present application.

FIG. 12 illustrates a structure block diagram of a processing device in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

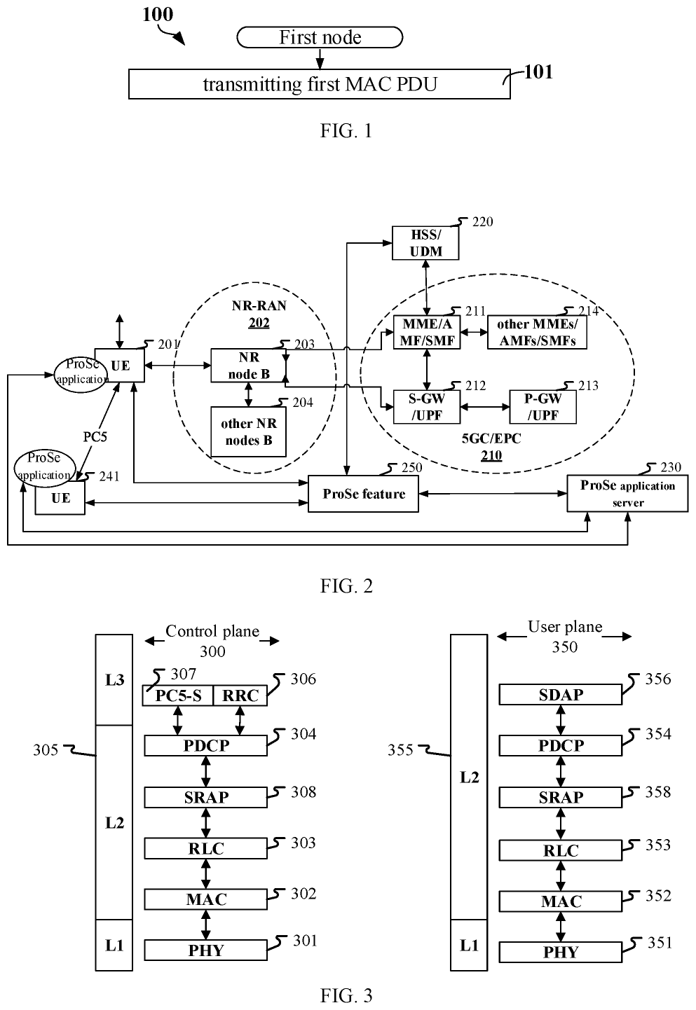

Embodiment 1 illustrates a flowchart of transmitting a first MAC PDU according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application transmits a first MAC PDU in step 101.

Herein, the first MAC PDU comprises a first MAC subPDU, the first MAC subPDU comprising a first MAC header and a first MAC subheader and a first MAC Service Data Unit (SDU), of which the first MAC SDU comprises a first Packet Data Convergence Protocol (PDCP) PDU; the first PDCP PDU being a PDCP PDU of a unicast sidelink RB;
herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU.

In one embodiment, the first node is a User Equipment (UE).

In one embodiment, the first node is in an RRC connected state.

In one embodiment, the first node is in an RRC inactive state.

In one embodiment, the first node is in an RRC idle state.

In one embodiment, a serving cell refers to a cell that the UE is camped on. Performing cell search includes that the UE searches for a suitable cell for a selected Public Land Mobile Network (PLMN) or Stand-alone Non-Public Network (SNPN), selects the suitable cell to provide available services, and monitors a control channel of the suitable cell, where the whole procedure is defined to be camped on the cell; in other words, relative to this UE, the cell being camped on is seen as a serving cell of the UE. Being camped on a cell in either RRC Idle state or RRC Inactive state is advantageous in the following aspects: enabling the UE to receive system information from a PLMN or an SNPN; after registration, if a UE hopes to establish an RRC connection or resume a suspended RRC connection, the UE can perform an initial access on a control channel of the camped cell to achieve such purpose; the network can page the UE; so that the UE can receive notifications from the Earthquake and Tsunami Warning System (ETWS) and the Commercial Mobile Alert System (CMAS).

In one embodiment, for a UE in RRC connected state without being configured with carrier aggregation/dual connectivity (CA/DC), there is only one serving cell that comprises a primary cell. For a UE in RRC connected state that is configured with carrier aggregation/dual connectivity (CA/DC), a serving cell is used for indicating a cell set comprising a Special Cell (SpCell) and all secondary cells. A Primary Cell is a cell in a Master Cell Group (MCG), i.e., an MCG cell, working on the primary frequency, and the UE performs an initial connection establishment procedure or initiates a connection re-establishment on the Primary Cell. For dual connectivity (DC) operation, a special cell refers to a Primary Cell (PCell) in an MCG or a Primary SCG Cell (PSCell) in a Secondary Cell Group (SCG); otherwise, the special cell refers to a PCell.

In one embodiment, working frequency of a Secondary Cell (SCell) is secondary frequency.

In one embodiment, separate contents in information elements (IEs) are called fields.

In one embodiment, Multi-Radio Dual Connectivity (MR-DC) refers to dual connectivity with an E-UTRA node and an NR node, or with two NR nodes.

In one embodiment, in MR-DC, a radio access node providing a control plane connection to the core network is a master node, where the master node can be a master eNB, a master ng-eNB or a master gNB.

In one embodiment, an MCG refers to a group of serving cells associated with a master node in MR-DC, including a SpCell, and optionally, one or multiple SCells.

In one embodiment, a PCell is a SpCell of an MCG.

In one embodiment, a PSCell is a SpCell of an SCG.

In one embodiment, in MR-DC, a radio access node not providing a control plane connection to the core network but providing extra resources for the UE is a secondary node. The secondary node can be an en-gNB, a secondary ng-eNB or a secondary gNB.

In one embodiment, in MR-DC, a group of serving cells associated with a secondary node is a secondary cell group (SCG), including a SpCell and, optionally, one or multiple SCells.

In one embodiment, an Access Stratum (AS) functionality that enables Vehicle-to Everything (V2X) communications defined in 3 GPP TS 23.285 is V2X sidelink communication, where the V2X sidelink communication occurs between nearby UEs, using E-UTRA techniques but not traversing network nodes.

In one embodiment, an Access Stratum (AS) functionality that at least enables Vehicle-to Everything (V2X) communications defined in 3GPP TS 23.287 is NR sidelink communication, where the NR sidelink communication occurs between two or more nearby UEs, using NR technology but not traversing network nodes.

In one embodiment, the sidelink (SL) refers to a UE-to-UE direct communication link that uses sidelink resource allocation mode, a physical signal or channel, and physical layer procedures.

In one embodiment, in the present application, any name of signaling or field or message that starts with “SL-” is for sidelink.

In one embodiment, not being or not located within coverage is equivalent to being out of coverage.

In one embodiment, being within coverage is equivalent to being covered.

In one embodiment, being out of coverage is equivalent to being uncovered.

In one embodiment, the first node is a UE to UE (U2U) relay node.

In one embodiment, the first node is a L2 U2U relay node.

In one embodiment, the relay in the present application is a U2U relay UE.

In one embodiment, when the first node is the generator of the first PDCP PDU, the first node is not a L2 U2U relay node.

In one embodiment, when the first node is not the generator of the first PDCP PDU, the first node is a L2 U2U relay node.

In one embodiment, the first MAC PDU is transmitted by sidelink.

In one embodiment, the first MAC PDU is transmitted by a PC5 interface.

In one embodiment, a physical channel occupied by the first MAC PDU includes a Physical Sidelink Shared Channel (PSSCH).

In one embodiment, a transmitter of the first MAC PDU is a UE.

In one embodiment, a generator of the first MAC PDU is a UE.

In one embodiment, a size of the first MAC SDU is not 0.

In one embodiment, the first MAC PDU comprises bit(s) other than padding bits.

In one embodiment, the first MAC PDU comprises a PDU of a higher-layer protocol layer.

In one embodiment, the first PDCP PDU is a data PDCP PDU.

In one embodiment, a type of the first PDCP PDU is a PDCP PDU of a unicast sidelink RB.

In one embodiment, the first PDCP PDU is generated by a first PDCP entity, where a radio bearer corresponding to the first PDCP entity is a unicast sidelink RB.

In one embodiment, the sidelink RB is or includes a sidelink DRB.

In one embodiment, the sidelink RB is or includes a sidelink Signaling Radio Bearer (SRB).

In one embodiment, the unicast sidelink RB is or includes a sidelink DRB for unicast.

In one embodiment, the unicast sidelink RB is or includes a sidelink Signaling Radio Bearer (SRB) for unicast.

In one embodiment, one PDCP entity respectively corresponds to one radio bearer.

In one embodiment, the generator of the first PDCP PDU is the generator of the first MAC PDU.

In one embodiment, when the first node is the generator of the first PDCP PDU, the first PDCP PDU is a PDCP PDU of a first unicast sidelink RB, the first unicast sidelink RB being not associated with an RLC channel; when the first node is not the generator of the first PD CP PDU, the first PD CP PDU is a PDCP PDU of a first unicast sidelink RB, the first unicast sidelink RB being associated with a first RLC channel.

In one embodiment, when the first node is the generator of the first PDCP PDU, the first PDCP PDU is a PDCP PDU of a first unicast sidelink RB, the first unicast sidelink RB being not associated with an RLC channel identity; when the first node is not the generator of the first PDCP PDU, the first PD CP PDU is a PDCP PDU of a first unicast sidelink RB, the first unicast sidelink RB being associated with a first RLC channel identity.

In one embodiment, the phrase of the first PDCP PDU being a PDCP PDU of a unicast sidelink radio bearer (RB) means: a DRB corresponding to or associated with or mapped to a PDCP entity that generates or receives the first PD CP PDU is a unicast sidelink RB.

In one embodiment, the phrase of the first PDCP PDU being a PDCP PDU of a unicast sidelink radio bearer (RB) means: the first PDCP PDU is for a unicast sidelink RB.

In one embodiment, the phrase of the first PDCP PDU being a PDCP PDU of a unicast sidelink radio bearer (RB) means: a format of the first PDCP PDU is a PDCP PDU format of a unicast sidelink RB.

In one embodiment, 5 least significant bits (LSB) of the target parameter are used as 5 input bits for security algorithm of the first PDCP PDU.

In one embodiment, 5 bits of the target parameter are as inputs of parameters of the security algorithm from BEARER[0] to BEARER[4].

In one embodiment, 5 least significant bits (LSB) of the target parameter are as inputs of parameters of the security algorithm from BEARER[0] to BEARER[4].

In one embodiment, the security algorithm includes encryption and/or integrity protection.

In one embodiment, the security algorithm is used for generating a key for encryption and/or integrity protection.

In one embodiment, security algorithm of the first PDCP PDU includes 128-NEAT and 128-NIA1.

In one embodiment, security algorithm of the first PDCP PDU includes 128-NEA2 and 128-NIA2.

In one embodiment, security algorithm of the first PDCP PDU includes 128-NEA3 and 128-NIA3.

In one embodiment, security algorithm of the first PDCP PDU includes 128-EEA1 and 128-EIA1.

In one embodiment, security algorithm of the first PDCP PDU includes 128-EEA2 and 128-EIA2.

In one embodiment, security algorithm of the first PDCP PDU includes 128-EEA3 and 128-EIA3.

In one embodiment, security algorithm of the first PDCP PDU includes SNOW.

In one embodiment, security algorithm of the first PDCP PDU includes AES.

In one embodiment, security algorithm of the first PDCP PDU includes ZUC.

In one embodiment, when the target parameter is a logical channel identity, the logical channel identity is a logical channel identity of a logical channel between the first node and the receiver of the first MAC PDU.

In one embodiment, a second field in the first MAC subheader indicates a receiver of the first MAC PDU.

In one embodiment, a logical channel between the first node and the receiver of the first MAC PDU is a logical channel between a MAC entity of the first node generating the first MAC PDU and a MAC entity of the first node receiving the first MAC PDU.

In one embodiment, when the target parameter is a logical channel identity, the first MAC subheader comprises the logical channel identity.

In one embodiment, the logical channel identity is a LCID.

In one embodiment, when the target parameter is a logical channel identity, a range of values for the logical channel identity is 4-19.

In one embodiment, the first PDCP PDU is used for bearing an RRC signaling.

In one subembodiment, the RRC signaling is a signaling of PC5 RRC.

In one embodiment, the first PDCP PDU is used for bearing a PC5-S signaling.

In one embodiment, the PC5-S is a signaling at a PC5 interface.

In one embodiment, the first PDCP PDU is used for bearing higher-layer data.

In one embodiment, the first PDCP PDU is used for bearing an IP packet.

In one embodiment, the target parameter is non-zero.

In one embodiment, the phrase that the target parameter is not a LCID means that: the target parameter is not used for a LCID of a logical channel of the first MAC PDU.

In one embodiment, the phrase that the target parameter is not a LCID means that: the target parameter is not used for a LCID comprised by the first MAC subheader.

In one embodiment, the phrase that the target parameter is not a LCID means that: the target parameter is not used for a LCID of a logical channel between the first node and a receiver of the first MAC PDU.

In one embodiment, the phrase that the target parameter is not a LCID means that: a LCID of a logical channel of the first MAC PDU is independent of the target parameter.

In one embodiment, the phrase that the target parameter is not a LCID means that: a LCID comprised by the first MAC subheader is independent of the value of the target parameter.

In one embodiment, the phrase that the target parameter is not a LCID means that: a LCID of a logical channel between the first node and a receiver of the first MAC PDU is independent of the target parameter.

In one embodiment, the phrase that the target parameter is not a LCID means that: the target parameter is not used for a LCID of a logical channel of the second MAC PDU.

In one embodiment, the phrase that the target parameter is not a LCID means that: the target parameter is not used for a LCID comprised by the second MAC subheader.

In one embodiment, the phrase that the target parameter is not a LCID means that: the target parameter is not used for a LCID of a logical channel between the second node and a receiver of the second MAC PDU.

In one embodiment, the phrase that the target parameter is not a LCID means that: a LCID of a logical channel of the second MAC PDU is independent of the target parameter.

In one embodiment, the phrase that the target parameter is not a LCID means that: a LCID comprised by the second MAC subheader is independent of the value of the target parameter.

In one embodiment, the phrase that the target parameter is not a LCID means that: a LCID of a logical channel between the first node and a transmitter of the second MAC PDU is independent of the target parameter.

In one embodiment, the phrase that the target parameter is not a LCID means that: the target parameter is of a length greater than 6 bits, and a LCID is of a size of 6 bits.

In one embodiment, the phrase that the target parameter is not a LCID means that: a length of the target parameter is different from a size of a LCID.

In one embodiment, the phrase that the target parameter is not a LCID means that: the target parameter is not an extended LCID.

In one embodiment, the LCID includes an extended LCID.

In one embodiment, the first key is used for indicating a key used by security algorithm of the first PDCP PDU.

In one embodiment, the identity of the first key is a K_{NRP-sess} ID.

In one embodiment, the first key is set up when establishing a secure connection.

In one embodiment, the first key is updated when updating a L2 identity.

In one embodiment, an identity of the first key comprises at least one non-zero bit.

In one embodiment, the identity of the first key comprises 16 bits.

In one embodiment, the first protocol layer is an adaptation layer.

In one embodiment, the first protocol layer is a Sidelink Relay Adaptation Protocol (SRAP) layer.

In one embodiment, the second protocol layer is a MAC layer.

In one embodiment, the second protocol layer is an RLC layer.

In one embodiment, the second protocol layer is a PDCP layer.

In one embodiment, the phrase that the target parameter is a state variable of a second protocol layer means that: the target parameter is a COUNT of the PDCP layer.

In one embodiment, the target parameter is COUNT.

In one embodiment, the target parameter is a sequence number (SN).

In one embodiment, the target parameter is a part of a SN.

In one embodiment, the target parameter includes a SN.

In one embodiment, the target parameter is a time-related parameter.

In one embodiment, the target parameter is a time-related state variable.

In one embodiment, the target parameter is a time stamp.

In one embodiment, the target parameter is a frame number.

In one embodiment, the target parameter is a subframe number.

In one embodiment, the target parameter is a slot number.

In one embodiment, the target parameter is determined by UTC time.

In one embodiment, the target parameter is a state variable for receiving.

In one embodiment, the target parameter is a state variable for transmitting.

In one embodiment, after the target parameter is determined, a change used to determine a state variable of the target parameter won't affect the target parameter.

In one embodiment, after the target parameter is determined, the target parameter changes with the change used to determine a state variable of the target parameter.

In one embodiment, the target parameter is used for identifying a link or a node.

In one embodiment, the target parameter is a L2 identity.

In one embodiment, the target parameter is part of bits in a L2 identity.

In one embodiment, the target parameter is an identity of a generator of the first PDCP PDU.

In one embodiment, the target parameter is a L2 identity of a generator of the first PDCP PDU.

In one embodiment, the target parameter is a Layer-2 identity of a generator of the first PDCP PDU.

In one embodiment, the target parameter is a link-layer identity of a generator of the first PDCP PDU.

In one embodiment, the target parameter is an identity of a receiver of the first PDCP PDU.

In one embodiment, the target parameter is a L2 identity of a receiver of the first PDCP PDU.

In one embodiment, the target parameter is a Layer-2 identity of a receiver of the first PDCP PDU.

In one embodiment, the target parameter is a link-layer identity of a receiver of the first PDCP PDU.

In one embodiment, the target parameter is an identity of a receiver of the first MAC PDU.

In one embodiment, the target parameter is a L2 identity of a receiver of the first MAC PDU.

In one embodiment, the target parameter is a Layer-2 identity of a receiver of the first MAC PDU.

In one embodiment, the target parameter is a link-layer identity of a receiver of the first MAC PDU.

In one embodiment, the target parameter is a UE_ID.

In one embodiment, the target parameter is a temporary identity.

In one embodiment, the target parameter is an application identity.

In one embodiment, the target parameter is a local identity.

In one embodiment, the target parameter is an identity assigned by the first node.

In one subembodiment, the first PDCP PDU is not generated by the first node.

In one embodiment, the target parameter is an identity of a PC5 direct unicast link.

In one embodiment, the target parameter is an identity of a link between the generator of the first PDCP PDU and a receiver of the first MAC PDU.

In one subembodiment, the first PDCP PDU is not generated by the first node.

In one embodiment, the target parameter is a bearer identity.

In one subembodiment, the first PDCP PDU is not generated by the first node.

In one embodiment, the target parameter is a BEARER ID.

In one embodiment, the target parameter is a BEARER_ID.

In one embodiment, the target parameter is an identity of a radio bearer between a generator of the first PDCP PDU and a receiver of the first MAC PDU.

In one embodiment, the target parameter is an identity of an RLC bearer between a generator of the first PDCP PDU and a receiver of the first MAC PDU.

In one embodiment, the target parameter is an identity of an RLC channel between a generator of the first PDCP PDU and a receiver of the first MAC PDU.

In one embodiment, the target parameter is an identity of a radio bearer between a transmitter of the second MAC PDU and a receiver of the first MAC PDU.

In one embodiment, the target parameter is an identity of an RLC bearer between a transmitter of the second MAC PDU and a receiver of the first MAC PDU.

In one embodiment, the target parameter is an identity of an RLC channel between a transmitter of the second MAC PDU and a receiver of the first MAC PDU.

In one embodiment, the target parameter is transparent to the first node.

In one embodiment, the target parameter is a peer-to-peer identity or identifier.

In one embodiment, the target parameter is a configuration index.

In one embodiment, the target parameter is an index.

In one embodiment, the second MAC PDU comprises or indicates the target parameter.

In one embodiment, the second MAC subheader comprises or indicates the target parameter.

In one embodiment, the first MAC PDU comprises or indicates the target parameter.

In one embodiment, the first MAC subheader comprises or indicates the target parameter.

In one embodiment, when the generator of the first PD CP PDU is not the first node, the first MAC subheader does not comprise the target parameter.

In one embodiment, the phrase that the first node is the generator of the first PDCP PDU means that: a PDCP entity generating the first PDCP PDU belongs to the first node.

In one embodiment, the phrase that the first node is the generator of the first PDCP PDU means that: a PDCP entity generating the first PDCP PDU is maintained by the first node.

In one embodiment, the phrase that the first node is not the generator of the first PDCP PDU means that: a PDCP entity generating the first PDCP PDU does not belong to the first node.

In one embodiment, the phrase that the first node is not the generator of the first PDCP PDU means that: a PDCP entity generating the first PDCP PDU is maintained by a node other than the first node.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called 5G System/Evolved Packet System (5GS/EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, the second node in the present application is the UE 201.

In one embodiment, the third node in the present application is the UE 201.

In one embodiment, a radio link from the UE 201 to the NR Node B is an uplink.

In one embodiment, a radio link from the NR Node B to the UE 201 is a downlink.

In one embodiment, the UE 201 supports relay transmission.

In one embodiment, the UE 201 includes cellphone.

In one embodiment, the UE 201 is a means of transportation including automobile.

In one embodiment, the gNB 203 is a MacroCellular base station.

In one embodiment, the gNB203 is a Micro Cell base station.

In one embodiment, the gNB203 is a Pico Cell base station.

In one embodiment, the gNB203 is a flight platform.

In one embodiment, the gNB203 is satellite equipment.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The PC5 Signaling Protocol (PC5-S) sublayer 307 is responsible for processing the signaling protocol at the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. An SRB can be seen as the service or interface provided by a PDCP layer for a higher layer, such as RRC layer. The SRBs in an NR system include SRB1, SRB2, and SRB3, and optionally, SRB4 when concerning sidelink communications, which are respectively used for transmitting all types of control signalings. The SRB is a bearer between a UE and an access network used for transmitting control signalings between them, including an RRC signaling. The SRB1 has special meaning to the UE, since for each UE that has established RRC connection, there is an SRB1 that is used for transmitting RRC signaling, and most signalings are transmitted via the SRB1. If the SRB1 is interrupted or cannot work, the UE will have to perform RRC re-establishment. The SRB2 is generally used for transmitting NAS signaling or any signaling concerning security. The UE can be configured without the SRB3. Unless for urgent traffics, the UE must establish an RRC connection with the network to proceed with communications. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.). For a UE involving relay services, its control plane can also comprise an Adaptation sublayer Sidelink Relay Adaptation Protocol (SRAP) 308, and its user plane can also comprise an Adaptation sublayer SRAP358. The introduction of the Adaptation layer is beneficial to lower layers, for instance, a MAC layer, or an RLC layer, to multiplex and/or distinguish data from multiple source UEs. For nodes not joined in relay communications, none of the PC5-S307, SRAP308 and SRAP358 will be needed in the process of communications.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first PDCP PDU in the present application is generated by the PDCP304 or the PDCP354.

In one embodiment, the first MAC PDU in the present application is generated by the MAC302 or the MAC352.

In one embodiment, the second MAC PDU in the present application is generated by the MAC302 or the MAC352.

In one embodiment, the third MAC PDU in the present application is generated by the MAC302 or the MAC352.

In one embodiment, the fourth MAC PDU in the present application is generated by the MAC302 or the MAC352.

In one embodiment, the first signaling in the present application is generated by the RRC 306 or the PC5-S307.

### Embodiment 4

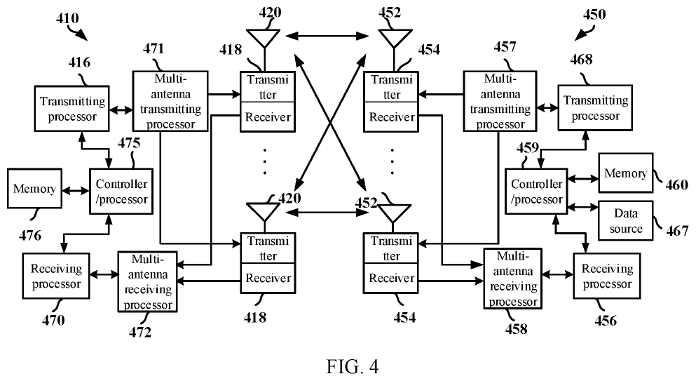

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the first communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: transmits a first MAC PDU, the first MAC PDU comprising a first MAC header and a first MAC subPDU, the first MAC subPDU comprising a first MAC sub-header and a first MAC SDU, the first MAC SDU comprising a first PDCP PDU; the first PDCP PDU being a PDCP PDU of a unicast sidelink RB; herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU.

In one embodiment, the first communication node 450 comprises a memory that stores a computer readable instruction program, the computer readable instruction program generates actions when executed by at least one processor, which include: transmitting a first MAC PDU, the first MAC PDU comprising a first MAC header and a first MAC subPDU, the first MAC subPDU comprising a first MAC sub-header and a first MAC SDU, the first MAC SDU comprising a first PDCP PDU; the first PDCP PDU being a PDCP PDU of a unicast sidelink RB; herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU.

In one embodiment, the first communication device 450 corresponds to the first node in the present application.

In one embodiment, the second communication device 410 corresponds to the second node in the present application.

In one embodiment, the second communication device 410 corresponds to the third node in the present application.

In one embodiment, the first communication device 450 is a UE.

In one embodiment, the first communication device 450 is a vehicle-mounted terminal.

In one embodiment, the first communication device 450 is a relay.

In one embodiment, the second communication device 410 is a UE.

In one embodiment, the second communication device 410 is a vehicle-mounted terminal.

In one embodiment, the second communication device 410 is wearable device.

In one embodiment, the second communication device 410 is an IoT device.

In one embodiment, the receiver 454 (comprising the antenna 452), the receiving processor 456 and the controller/processor 459 are used for receiving the second MAC PDU in the present application.

In one embodiment, the receiver 454 (comprising the antenna 452), the receiving processor 456 and the controller/processor 459 are used for receiving the third MAC PDU in the present application.

In one embodiment, the transmitter 454 (comprising the antenna 452), the transmitting processor 468 and the controller/processor 459 are used for transmitting the first MAC PDU in the present application.

In one embodiment, the transmitter 454 (comprising the antenna 452), the transmitting processor 468 and the controller/processor 459 are used for transmitting the fourth MAC PDU in the present application.

### Embodiment 5

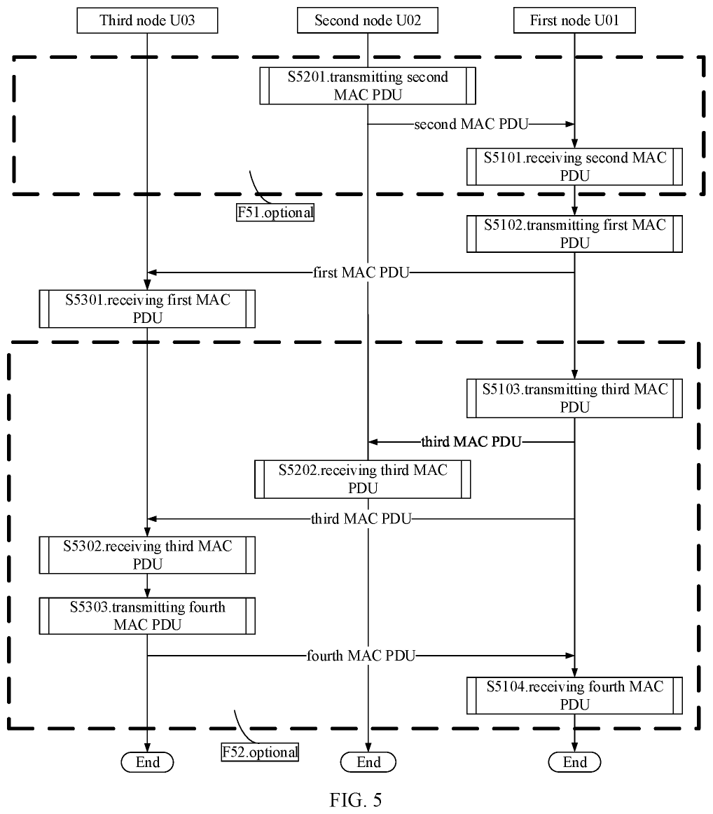

Embodiment 5 illustrates a flowchart of radio signal transmission according to one embodiment of the present application, as shown in FIG. 5. In FIG. 5, U01 corresponds to the first node in the present application. It should be particularly noted that the sequence illustrated herein does not set any limit on the orders in which signals are transmitted and implementations in this present application. Herein, steps in F51 and F52 are optional.

The first node U01 receives a second MAC PDU in step S5101; and transmits a first MAC PDU in step S5102; and transmits a third MAC PDU in step S5103; and receives a fourth MAC PDU in step S5104.

The second node U02 transmits a second MAC PDU in step S5201; and receives a third MAC PDU in step S5202.

The third node U03 receives a first MAC PDU in step S5301; and receives a third MAC PDU in step S5302; and transmits a fourth MAC PDU in step S5303.

In Embodiment 5, the first MAC PDU comprises a first MAC header and a first MAC subPDU, the first MAC subPDU comprising a first MAC sub-header and a first MAC SDU, the first MAC SDU comprising a first PDCP PDU; the first PDCP PDU being a PDCP PDU of a unicast sidelink RB;
herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU; in Embodiment 5, the first node is not a generator of the first PDCP PDU.

In one embodiment, the first node U01 is a UE.

In one embodiment, the first node U01 is a L2 U2U relay UE.

In one embodiment, the second node U02 is a UE.

In one embodiment, the second node U02 is a remote UE.

In one embodiment, the third node U03 is a UE.

In one embodiment, the third node U03 is a remote UE.

In one embodiment, the first node U01 is a relay for communications between the second node U02 and the third node U03.

In one embodiment, the step S5101 is performed before the step S5102.

In one embodiment, the step S5103 is performed before the step S5101.

In one embodiment, the step S5103 is performed before the step S5104.

In one embodiment, the step S5302 is performed before the step S5303.

In one embodiment, the third MAC PDU is transmitted to the second node U02 by the first node U01.

In one embodiment, the third MAC PDU is transmitted to the third node U03 by the first node U01.

In one embodiment, a sidelink is used for communications between the first node U01 and the second node U02.

In one embodiment, a sidelink is used for communications between the first node U01 and the third node U03.

In one embodiment, there exists no communication link between the third node U03 and the second node U02.

In one embodiment, there exists a communication link between the third node U03 and the second node U02.

In one embodiment, an air interface between the first node U01 and the second node U02 is a PC5.

In one embodiment, an air interface between the third node U03 and the second node U02 is a PC5.

In one embodiment, an air interface between the first node U01 and the third node U03 is a PC5.

In one embodiment, the second MAC PDU is used for generating the first MAC PDU.

In one embodiment, the second MAC PDU comprises a second MAC header and a second MAC subPDU, the second MAC subPDU comprising a second MAC subheader and a second MAC SDU, the second MAC SDU comprising the first PDCP PDU.

In one embodiment, the sentence that the second MAC PDU is used for generating the first MAC PDU means that: partial bits in the first MAC PDU are from the second MAC PDU.

In one embodiment, the sentence that the second MAC PDU is used for generating the first MAC PDU means that: the first MAC PDU is used for forwarding a MAC SDU carried by the second MAC PDU.

In one embodiment, the sentence that the second MAC PDU is used for generating the first MAC PDU means that: the first MAC PDU is used for forwarding the first PDCP PDU carried by the second MAC PDU.

In one embodiment, the sentence that the second MAC PDU is used for generating the first MAC PDU

means that: the first MAC PDU and the second MAC PDU comprise an identical higher layer PDU.

In one embodiment, a higher layer of a user plane refers to an RLC layer or a PDCP layer.

In one embodiment, a higher layer of a control plane refers to an RRC layer or a PC5-S layer.

In one embodiment, a PC5-S layer belongs to a NAS.

In one embodiment, the sentence that the first MAC SDU comprises the first PDCP PDU means that: the first MAC SDU comprises all of the first PDCP PDU.

In one embodiment, the sentence that the first MAC SDU comprises the first PDCP PDU means that: the first MAC SDU comprises a segment of the first PDCP PDU.

In one embodiment, the sentence that the second MAC SDU comprises the first PDCP PDU means that: the second MAC SDU comprises all of the first PDCP PDU.

In one embodiment, the sentence that the second MAC SDU comprises the first PDCP PDU means that: the second MAC SDU comprises a segment of the first PDCP PDU.

In one embodiment, a generator of the second MAC PDU is the second node U02.

In one embodiment, a generator of the first PDCP PDU is the second node U02.

In one embodiment, the sentence that a generator of the first PDCP PDU is the second node U02 means that: a PDCP entity generating the first PDCP PDU is in the second node U02.

In one embodiment, the second MAC header comprises a first field and a second field, where the first field in the second MAC header indicates the generator of the first PDCP PDU, while the second field in the second MAC header indicates the first node U01.

In one embodiment, the first MAC header comprises a first field and a second field, where the first field comprised by the first MAC header indicates the first node U01; while the second field comprised by the first MAC header indicates a receiver of the first MAC PDU.

In one embodiment, the first field is a SRC field, while the second field is a DST field.

In one embodiment, the first field in the second MAC header indicates the second node U02.

In one embodiment, a receiver of the first MAC PDU is the third node U03.

In one embodiment, the second field comprised by the first MAC header indicates the third node U03.

In one embodiment, the third MAC PDU comprises a third MAC header and a third MAC subPDU, the third MAC subPDU comprising a third MAC subheader and a third MAC SDU, the third MAC SDU comprising a first signaling, the first signaling used for indicating the target parameter.

In one embodiment, the third MAC header comprises a first field and a second field, where the first field in the third MAC header indicates the first node, while the second field in the third MAC header indicates one of a generator of the first PDCP PDU or a receiver of the first MAC PDU.

In one embodiment, the third MAC SDU is used for bearing the first signaling.

In one embodiment, the first signaling is an RRC signaling at a PC5 interface.

In one embodiment, the first signaling is a PC5-S signaling.

In one embodiment, the first signaling comprises a RRCReconfigurationSidelink message.

In one embodiment, the first node U01 configures or indicates the target parameter to a receiver of the first MAC PDU.

In one embodiment, the first node U01 configures or indicates the target parameter to a transmitter of the second MAC PDU.

In one embodiment, the third MAC PDU is transmitted by sidelink.

In one embodiment, the first signaling comprises the target parameter.

In one embodiment, the first signaling comprises an identity or index of the target parameter.

In one embodiment, a receiver of the third MAC PDU is a receiver of the first MAC PDU.

In one embodiment, a receiver of the third MAC PDU is a transmitter of the second MAC PDU.

In one embodiment, a receiver of the third MAC PDU is the second node U02.

In one embodiment, a receiver of the third MAC PDU is the third node U03.

In one embodiment, a generator of the first PDCP PDU indicates the target parameter to the first node U01, and the first node U01 indicates the target parameter to a receiver of the first MAC PDU.

In one subembodiment, the first node U01 transmits the third MAC PDU according to the target parameter being indicated.

In one embodiment, a receiver of the first MAC PDU indicates the target parameter to the first node U01;

the first node U01 indicates the target parameter to a generator of the first PDCP PDU.

In one subembodiment, the first node U01 transmits the third MAC PDU according to the target parameter being indicated.

In one embodiment, the first node U01 configures the target parameter for a node of a last hop and a node of a next hop.

In one embodiment, the first node U01 configures the target parameter of a node of a last hop and a node of a next hop.

In one embodiment, the first node U01 configures the target parameter of a remote UE.

In one embodiment, the fourth MAC PDU comprises a fourth MAC header and a fourth MAC subPDU, the fourth MAC subPCU comprising a fourth MAC subheader and a fourth MAC SDU, the fourth MAC SDU comprising a second PDCP PDU; the second PDCP PDU being a PDCP PDU of a unicast sidelink RB; the target parameter is used for security algorithm of the second PDCP PDU.

In one embodiment, the fourth MAC header comprises a first field and a second field, where the first field in the fourth MAC header indicates a receiver of the first MAC PDU; while the second field in the fourth MAC header indicates the first node U01.

In one embodiment, the fourth MAC PDU is transmitted by sidelink.

In one embodiment, the second PDCP PDU is different from the first PDCP PDU.

In one embodiment, the second PDCP PDU uses a same security algorithm as the first PDCP PDU.

In one embodiment, a generator of the second PDCP PDU is different from that of the first PDCP PDU.

In one embodiment, the first node U01 forwards the second PDCP PDU.

In one embodiment, the first node U01 forwards the second PDCP PDU to a node other than a generator of the second PDCP PDU.

In one embodiment, the first node U01 forwards the second PDCP PDU to the second node U02.

In one embodiment, a generator of the second PDCP PDU is the third node U03.

In one embodiment, a generator of the fourth MAC PDU is the third node U03.

In one embodiment, a PDCP entity of a receiving end for the second PDCP PDU does not belong to the first node U01.

In one embodiment, a PDCP entity of a receiving end for the second PDCP PDU belongs to the second node U02.

In one embodiment, a header of the second PDCP PDU comprises an identity of the first key.

In one embodiment, the first key is used for security algorithm of the second PDCP PDU.

In one embodiment, the target parameter is not a logical channel identity (LCID).

In one embodiment, 5 least significant bits (LSB) of the target parameter are used for security algorithm of the first PDCP PDU.

In one embodiment, 5 least significant bits (LSB) of the target parameter are used for security algorithm of the second PDCP PDU.

In one embodiment, the first MAC SDU comprises a PDU of a first protocol layer, the first protocol layer being a protocol layer between an RLC layer and a PDCP layer, with a header of the PDU of the first protocol layer comprising the target parameter; herein, the generator of the first PDCP PDU is a node other than the first node U01.

In one embodiment, when the generator of the first PDCP PDU is the first node, the first MAC SDU does not comprise a PDU of a first protocol layer.

In one embodiment, the second MAC SDU comprises a PDU of a first protocol layer, the first protocol layer being a protocol layer between an RLC layer and a PDCP layer, with a header of the PDU of the first protocol layer comprising the target parameter; herein, the generator of the first PDCP PDU is a node other than the first node U01.

### Embodiment 6

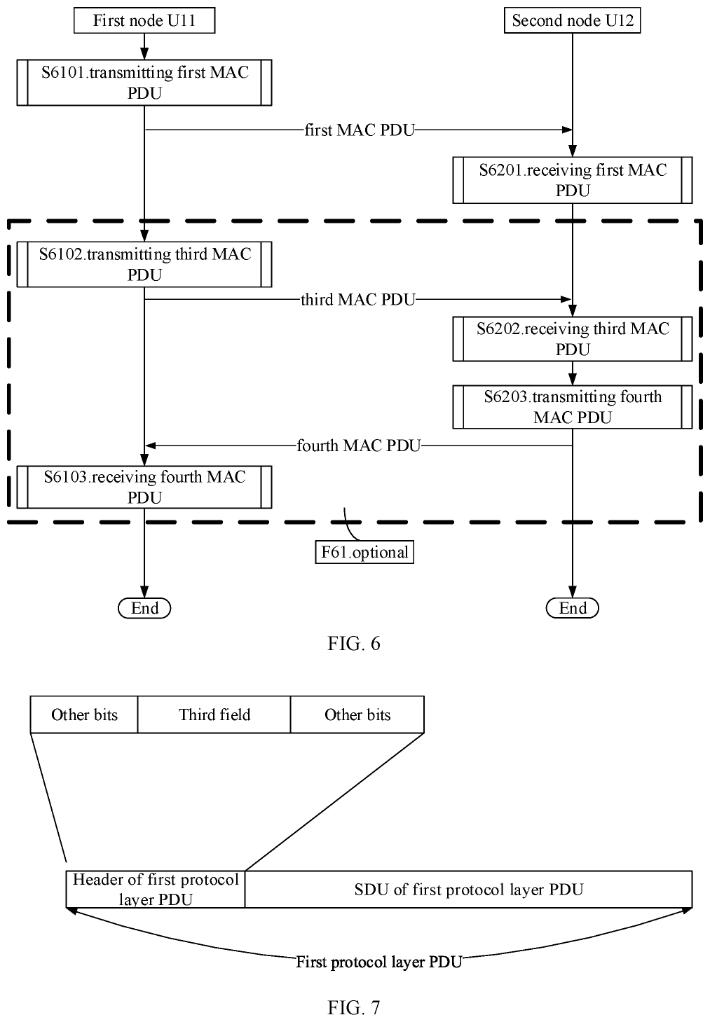

Embodiment 6 illustrates a flowchart of radio signal transmission according to one embodiment of the present application, as shown in FIG. 6. In FIG. 6, U11 corresponds to the first node in the present application. It should be particularly noted that the sequence illustrated herein does not set any limit on the orders in which signals are transmitted and implementations in this present application. Herein, steps in F61 are optional.

The first node U11 transmits a first MAC PDU in step S6101; and transmits a third MAC PDU in step S6102; and receives a fourth MAC PDU in step S6103.

The second node U12 receives a first MAC PDU in step S6201; and receives a third MAC PDU in step S6202; and transmits a fourth MAC PDU in step S6203.

In Embodiment 6, the first MAC PDU comprises a first MAC header and a first MAC subPDU, the first MAC subPDU comprising a first MAC sub-header and a first MAC SDU, the first MAC SDU comprising a first PDCP PDU; the first PDCP PDU being a PDCP PDU of a unicast sidelink RB;
herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU; in Embodiment 6, the first node is a generator of the first PDCP PDU.

In one embodiment, the first node U11 is a UE.

In one embodiment, the first node U11 is in direct communication with the second node U12.

In one embodiment, no relay is used by communications between the first node U11 and the second node U12.

In one embodiment, the second node U12 is a UE.

In one embodiment, the first node U11 is a remote UE.

In one embodiment, the second node U12 is a remote UE.

In one embodiment, the second node U12 is not a relay node of the first node U11.

In one embodiment, an air interface between the first node U11 and the second node U12 is a PC5.

In one embodiment, the step S6102 is performed before the step S6101.

In one embodiment, the step S6102 is performed before the step S6103.

In one embodiment, the step S6202 is performed before the step S6201.

In one embodiment, the step S6202 is performed before the step S6203.

In one embodiment, the first node U11 is a generator of the first MAC PDU.

In one embodiment, as given in Embodiment 6, the target parameter is a logical channel identity (LCID).

In one embodiment, the target parameter is an identity of a logical channel between the first node U11 and the second node U12.

In one embodiment, the target parameter is an identity of a logical channel occupied by the first MAC PDU.

In one embodiment, the target parameter is an identity of a logical channel occupied by the third MAC PDU.

In one embodiment, the first MAC header comprises a first field and a second field, where the first field comprised by the first MAC header indicates the first node U11; while the second field comprised by the first MAC header indicates a receiver of the first MAC PDU.

In one embodiment, the first field is a SRC field, while the second field is a DST field.

In one embodiment, a receiver of the first MAC PDU is the second node U12.

In one embodiment, the second field comprised by the first MAC header indicates the second node U12.

In one embodiment, the third MAC PDU comprises a third MAC header and a third MAC subPDU, the third MAC subPDU comprising a third MAC subheader and a third MAC SDU, the third MAC SDU comprising a first signaling, the first signaling used for indicating the target parameter.

In one embodiment, the third MAC header comprises a first field and a second field, where the first field in the third MAC header indicates the first node, while the second field in the third MAC header indicates a receiver of the first MAC PDU.

In one embodiment, the third MAC SDU is used for bearing the first signaling.

In one embodiment, the first signaling is an RRC signaling at a PC5 interface.

In one embodiment, the first signaling is a PC5-S signaling.

In one embodiment, the first signaling comprises a RRCReconfigurationSidelink message.

In one embodiment, the first node U11 configures or indicates the target parameter to a receiver of the first MAC PDU.

In one embodiment, the third MAC PDU is transmitted by sidelink.

In one embodiment, the first signaling comprises the target parameter.

In one embodiment, the first signaling comprises an identity or index of the target parameter.

In one embodiment, a receiver of the third MAC PDU is a receiver of the first MAC PDU.

In one embodiment, a receiver of the third MAC PDU is the second node U02.

In one embodiment, a receiver of the first PDCP PDU is the second node U12.

In one embodiment, the fourth MAC PDU comprises a fourth MAC header and a fourth MAC subPDU, the fourth MAC subPCU comprising a fourth MAC subheader and a fourth MAC SDU, the fourth MAC SDU comprising a second PDCP PDU; the second PDCP PDU being a PDCP PDU of a unicast sidelink RB; the target parameter is used for security algorithm of the second PDCP PDU.

In one embodiment, the fourth MAC header comprises a first field and a second field, where the first field in the fourth MAC header indicates a receiver of the first MAC PDU; while the second field in the fourth MAC header indicates the first node U11.

In one embodiment, the fourth MAC PDU is transmitted by sidelink.

In one embodiment, the second PDCP PDU is different from the first PDCP PDU.

In one embodiment, the second PDCP PDU uses a same security algorithm as the first PDCP PDU.

In one embodiment, a generator of the second PDCP PDU is different from that of the first PDCP PDU.

In one embodiment, the first node U11 does not forward the second PDCP PDU.

In one embodiment, the first node U11 receives and processes the second PDCP PDU.

In one embodiment, a generator of the fourth MAC PDU is the second node U12.

In one embodiment, a PDCP entity of a receiving end for the second PDCP PDU belongs to the first node U11.

In one embodiment, a header of the second PDCP PDU comprises an identity of the first key.

In one embodiment, the first key is used for security algorithm of the second PDCP PDU.

In one embodiment, 5 least significant bits (LSB) of the target parameter are used for security algorithm of the first PDCP PDU.

In one embodiment, 5 least significant bits (LSB) of the target parameter are used for security algorithm of the second PDCP PDU.

In one embodiment, an identity of a logical channel occupied by the third MAC PDU is the target parameter.

In one embodiment, an identity of a logical channel occupied by the fourth MAC PDU is the target parameter.

### Embodiment 7

Embodiment 7 illustrates a schematic diagram of a first protocol layer PDU according to one embodiment of the present application, as shown in FIG. 7.

A first protocol layer PDU in Embodiment 7 is generated or received by the sublayer AP308 or the sublayer AP358 in Embodiment 3.

The first protocol layer PDU in Embodiment 7 comprises a header of the first protocol layer PDU, and an SDU carried by the first protocol layer PDU; the first protocol layer PDU probably carries padding.

In one embodiment, a header of the first protocol layer PDU comprises a third field.

In one embodiment, some other bits may be comprised, optionally, before the third field comprised by a header of the first protocol layer PDU.

In one embodiment, some other bits may be comprised, optionally, after the third field comprised by a header of the first protocol layer PDU.

In one embodiment, the third field comprised by a header of the first protocol layer PDU received by the first node indicates the target parameter.

In one embodiment, the third field comprised by a header of the first protocol layer PDU received by the first node indicates part of or all bits in the target parameter.

In one embodiment, the third field comprised by a header of the first protocol layer PDU comprises 5 bits.

In one embodiment, the third field comprised by a header of the first protocol layer PDU comprises 6 bits.

In one embodiment, the third field comprised by a header of the first protocol layer PDU comprises 8 bits.

In one embodiment, the third field comprised by a header of the first protocol layer PDU comprises 16 bits.

In one embodiment, the third field comprised by a header of the first protocol layer PDU comprises 24 bits.

In one embodiment, the third field comprised by a header of the first protocol layer PDU comprises 32 bits.

In one embodiment, an SDU of the first protocol layer PDU comprises the first PDCP PDU.

In one embodiment, an SDU of the first protocol layer PDU comprises the second PDCP PDU.

In one embodiment, the first MAC SDU in the present application comprises at least one first protocol layer PDU.

In one subembodiment, the generator of the first PDCP PDU is not the first node.

In one subembodiment, the target parameter is not a logical channel identity (LCID).

In one embodiment, the second MAC SDU in the present application comprises at least one first protocol layer PDU.

In one subembodiment, the generator of the first PDCP PDU is not the first node.

In one subembodiment, the target parameter is not a logical channel identity (LCID).

In one embodiment, the third MAC SDU in the present application comprises at least one first protocol layer PDU.

In one subembodiment, the generator of the first PDCP PDU is not the first node.

In one subembodiment, the target parameter is not a logical channel identity (LCID).

In one embodiment, the fourth MAC SDU in the present application comprises at least one first protocol layer PDU.

In one subembodiment, the generator of the first PDCP PDU is not the first node.

In one subembodiment, the target parameter is not a logical channel identity (LCID).

In one embodiment, an SDU carried by a first protocol layer PDU comprises the first PDCP PDU.

In one embodiment, an SDU carried by a first protocol layer PDU comprises the second PDCP PDU.

In one embodiment, the third field comprised by a header of the first protocol layer PDU comprises or indicates an identity of a bearer or an index of the bearer.

In one embodiment, the third field comprised by a header of the first protocol layer PDU comprises or indicates an identity of a link or an index of a bearer.

In one embodiment, the third field comprised by a header of the first protocol layer PDU comprises or

indicates an identity of a channel or an index of a bearer.

In one embodiment, the third field comprised by a header of the first protocol layer PDU comprises or indicates an identity of an RLC channel or an index of a bearer.

In one embodiment, the third field comprised by a header of the first protocol layer PDU comprises or indicates an identity of a configuration or an index of a bearer.

In one embodiment, the third field comprised by a header of the first protocol layer PDU comprises or indicates an identity of an application or an index of a bearer.

In one embodiment, the third field comprised by a header of the first protocol layer PDU comprises or indicates an identity of a generator of the first protocol layer PDU.

In one embodiment, the third field comprised by a header of the first protocol layer PDU comprises or indicates an identity of a receiver of the first protocol layer PDU.

In one embodiment, the identity of a receiver of the first protocol layer PDU is a local identity.

In one embodiment, the identity of a receiver of the first protocol layer PDU is a temporary identity.

In one embodiment, the identity of a receiver of the first protocol layer PDU is a L2 identity.

In one embodiment, the identity of a receiver of the first protocol layer PDU is a link-layer identity.

In one embodiment, the identity of a receiver of the first protocol layer PDU is a UE_ID.

In one embodiment, the identity of a transmitter of the first protocol layer PDU is a local identity.

In one embodiment, the identity of a transmitter of the first protocol layer PDU is a temporary identity.

In one embodiment, the identity of a transmitter of the first protocol layer PDU is a L2 identity.

In one embodiment, the identity of a transmitter of the first protocol layer PDU is a link-layer identity.

In one embodiment, the identity of a transmitter of the first protocol layer PDU is a UE_ID.

In one embodiment, a receiver of the first MAC PDU is a receiver of a first protocol layer PDU comprised by the first MAC SDU.

In one embodiment, a transmitter of the second MAC PDU is a transmitter of a first protocol layer PDU comprised by the second MAC SDU.

In one embodiment, the first protocol layer is an SRAP.

In one embodiment, a header of a first protocol layer PDU comprises partial bits of the target parameter.

In one embodiment, 2 or over 2 fields in a header of a first protocol layer PDU comprise the target parameter.

In one embodiment, 2 or over 2 fields in a header of a first protocol layer PDU indicate the target parameter.

In one embodiment, a third field and a field other than the third field in a header of a first protocol layer PDU indicate the target parameter.

### Embodiment 8

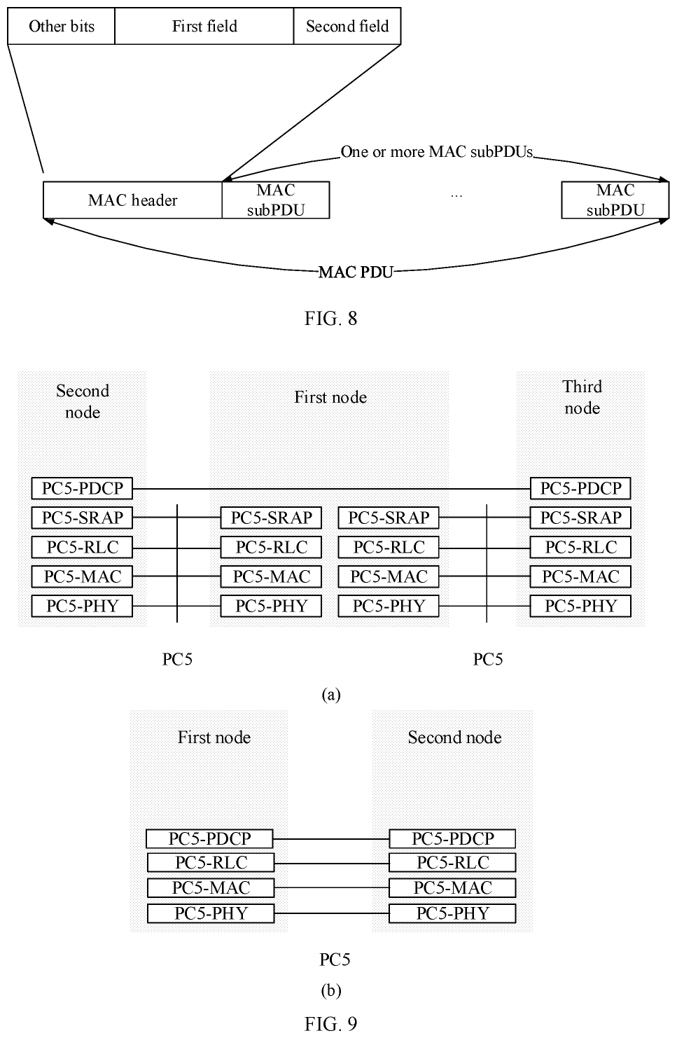

Embodiment 8 illustrates a schematic diagram of a MAC PDU according to one embodiment of the present application, as shown in FIG. 8.

In Embodiment 8, a MAC PDU comprises a MAC Header and at least one MAC subPDU; the MAC Header comprises a source ID, a destination ID and other bits.

In one embodiment, the MAC PDU is transmitted on a SideLink Shared CHannel (SL-SCH).

In one embodiment, the number of bits comprised by the MAC Header is fixed.

In one embodiment, the number of bits comprised by the MAC Header is 32.

In one embodiment, the MAC Header is a SL-SCH MAC header.

In one embodiment, the MAC Header is a SL-SCH MAC subheader.

In one embodiment, the other bits comprise 5 fields, namely, V, R, R, R and R, in which the numbers of bits respectively comprised are 4, 1, 1, 1 and 1.

In one embodiment, the first field and the second field respectively comprise 16 bits of a source ID and 8 bits of a destination ID.

In one embodiment, the first field and the second field respectively comprise 16 most significant bits (MSB) of a source ID and 8 most significant bits (MSB) of a destination ID.

In one embodiment, each of the source ID and the destination ID respectively comprises 24 bits.

In one embodiment, a first field and a second field in the MAC header are respectively a SRC field and a DST field.

In one embodiment, a first field in the MAC header indicates a source ID.

In one embodiment, a first field in the MAC header indicates a transmitter.

In one embodiment, a second field in the MAC header indicates a destination ID.

In one embodiment, a second field in the MAC header indicates a receiver.

In one embodiment, the source ID corresponds to or indicates a link layer identity.

In one embodiment, the source ID corresponds to or indicates a L2 identity.

In one embodiment, the destination ID corresponds to or indicates a link layer identity.

In one embodiment, the destination ID corresponds to or indicates a L2 identity.

In one embodiment, each MAC subPDU comprises a MAC subheader and a MAC SDU, where the MAC subheader in each MAC subPDU comprises a Logical Channel IDentity (LCID) field, the LCID field indicating an identity of a logical channel for a corresponding MAC SDU.

In one embodiment, a MAC subheader only comprises one LCID field.

In one embodiment, the LCID field indicates the Logical Channel IDentity (LCID) in the present application.

In one embodiment, when the first node is not a generator of a first PDCP PDU, the LCID field indicates the target parameter.

In one embodiment, the LCID field comprises 5 bits.

In one embodiment, the LCID field comprises 6 bits.

In one embodiment, the MAC SDU field bears a first protocol layer PDU in the present application.

In one embodiment, the MAC SDU field bears the first PDCP PDU in the present application.

In one embodiment, the MAC SDU field bears the second PDCP PDU in the present application.

In one embodiment, the MAC PDU in FIG. 8 is the first MAC PDU in the present application.

In one embodiment, the MAC PDU in FIG. 8 is the second MAC PDU in the present application.

In one embodiment, the MAC PDU in FIG. 8 is the third MAC PDU in the present application.

In one embodiment, the MAC PDU in FIG. 8 is the fourth MAC PDU in the present application.

In one embodiment, the phrase that the target parameter is a LCID means that: the target parameter is indicated by a LCID field in the first MAC subheader.

In one embodiment, the phrase that the target parameter is a LCID means that: the target parameter is indicated by a LCID field in the second MAC subheader.

In one embodiment, the phrase that the target parameter is a LCID means that: the target parameter is indicated by a LCID field in one of the first MAC subheader or the second MAC subheader.

In one embodiment, the phrase that the target parameter is a LCID means that: the target parameter is not a virtual LCID.

In one embodiment, the phrase that the target parameter is not a LCID means that: the target parameter is a virtual LCID.

In one embodiment, the phrase that the target parameter is not a LCID means that: the target parameter is not a virtual LCID.

### Embodiment 9

Embodiment 9 illustrates a schematic diagram of protocol stack according to one embodiment of the present application, as shown in FIG. 9.

FIG. 9 is made up of two sub-figures (a) and (b).

The protocol stack illustrated in FIG. 9 is applicable to L2 U2U relay communications, with the Embodiment 3 as the foundation of Embodiment 9.

Sub-figure (a) in FIG. 9 corresponds to a user plane protocol stack in L2 U2U relay communications.

In one embodiment, the first node in (a) of FIG. 9 is the relay when using an indirect path.

In one embodiment, the first node in (a) of FIG. 9 is a relay node for communications between a second node and a third node.

In one embodiment, an interface of communication between the first node and the second node is a PC5.

In one embodiment, the first air interface is a PC5.

In one embodiment, the first node and the second node are both UEs.

In one embodiment, the third node is a UE.

In one embodiment, as shown in (a), the protocol stack {PC5-PDCP} of a first air interface terminates at the second node and the third node, a PDCP PDU of the second node is forwarded by the first node and the first node does not modify the PDCP PDU being forwarded, in other words, the PDCP PDU transmitted to the third node from the second node is transparent to the first node.

In one embodiment, similar to (a), a signaling of a control plane between the second node and the third node, including an RRC signaling, or a PC5-S signaling, is also forwarded by the first node, and the first node does not modify anything in the content of the forwarded control-plane signaling, so the protocol entity of the control-plane signaling terminates at the second node and the third node.

In one embodiment, as shown in (a), the PC5-SRAP corresponds to the SRAP307 in FIG. 3, the PC5-RLC corresponds to the RLC303 in FIG. 3, the PC5-MAC corresponds to the MAC302 in FIG. 3, and the PC5-PHY corresponds to the PHY301 in FIG. 3.

In one embodiment, a PC5-SRAP is only used for a specific message or specific data.

In one embodiment, when the first PDCP PDU is not generated by the first node, the target parameter is used for identifying a link between the second node and the third node.

In one embodiment, when the first PDCP PDU is generated by the first node, the target parameter is used for identifying a logical channel between the second node and the first node, or the target parameter is used for identifying a logical channel between the third node and the first node.

In one embodiment, when the first PDCP PDU is generated by the first node, the target parameter is used for identifying a virtual logical channel between the second node and the third node.

In one embodiment, as shown in (a), the first PDCP PDU is generated by a PC5-PDCP entity.

In one embodiment, as shown in (a), the first PDCP PDU is generated by a PC5-PDCP entity of the second node.

In one embodiment, as shown in (a), the first PDCP PDU is received and processed by a PC5-PDCP entity of the third node.

In one embodiment, as shown in (a), the second PDCP PDU is generated by a PC5-PDCP entity.

In one embodiment, as shown in (a), the second PDCP PDU is generated by a PC5-PDCP entity of the third node.

In one embodiment, as shown in (a), the second PDCP PDU is received and processed by a PC5-PDCP entity of the second node.

In one embodiment, as shown in (b), the first PDCP PDU is generated by the first node.

In one embodiment, as shown in (b), no relay is used.

In one embodiment, as shown in (b), the first protocol layer is not used.

In one embodiment, as shown in (b), a PC5-SRAP is not used.

In one embodiment, as shown in (b), the first PDCP PDU is generated by a PC5-PDCP entity of the first node.

In one embodiment, as shown in (b), the first PDCP PDU is received and processed by a PC5-PDCP entity of the second node.

In one embodiment, as shown in (b), the second PDCP PDU is generated by a PC5-PDCP entity of the second node.

In one embodiment, as shown in (b), the second PDCP PDU is received and processed by a PC5-PDCP entity of the first node.

In one embodiment, as shown in (b), the target parameter is a logical channel between the first node and the second node.

In one embodiment, the first MAC PDU is transmitted by the first air interface.

### Embodiment 10

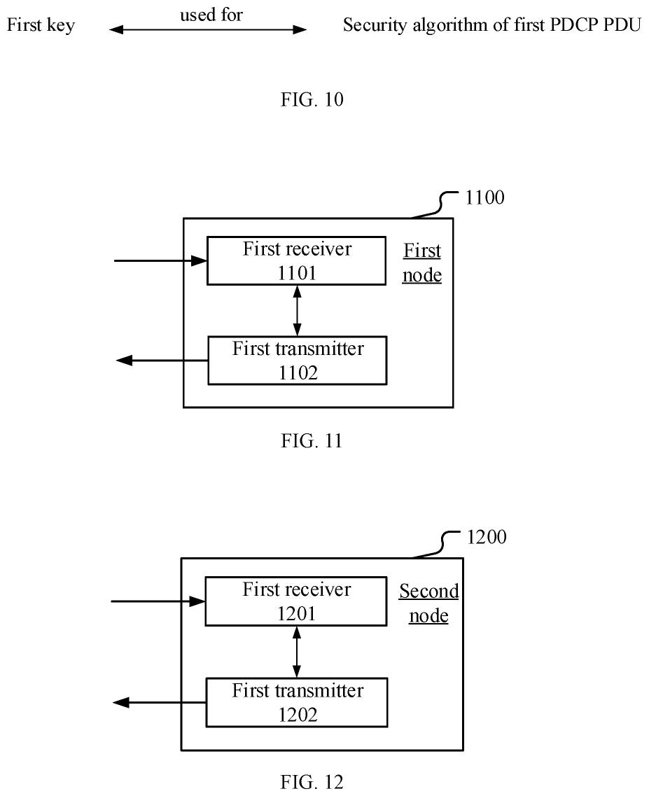

Embodiment 10 illustrates a schematic diagram showing a first key used for security algorithm of a first PDCP PDU according to one embodiment of the present application, as shown in FIG. 10.

In one embodiment, an identity of the first key includes a first K_{D} ID, the first K_{D} ID being a K_{D} identity.

In one embodiment, an identity of the first key includes a first K_{D-sess} ID, the first K_{D-sess} ID being a K_{D-sess} identity.

In one embodiment, the first key is determined to be a key for communications from the second node to the third node.

In one embodiment, a field in a header of the first PDCP PDU comprises N1 bit(s) of the identity of the first key, where N1 is a positive integer.

In one subembodiment, N1 is 16.

In one embodiment, a field in a header of the first PDCP PDU comprises N1 most significant bit(s) of the identity of the first key, where N1 is a positive integer.

In one subembodiment, N1 is 16.

In one embodiment, an identity of the first key comprises more than 16 bits.

In one embodiment, the first key is or includes a K_{NRP-sess}.

In one embodiment, the first key is or includes a K_{NRP}.

In one embodiment, the sentence that a first key is used for security algorithm of a first PDCP PDU means that: the first key is used for generating a key used by the security algorithm applied to the first PDCP PDU.

In one embodiment, the sentence that “a first key is used for security algorithm of a first PDCP PDU” comprises the following meaning: the first key is used for generating a key used by security algorithm applied to the first PDCP PDU.

In one embodiment, the sentence that “a first key is used for security algorithm of a first PDCP PDU” comprises the following meaning: the security algorithm applied to the first PDCP PDU includes enciphering.

In one embodiment, the sentence that “a first key is used for security algorithm of a first PDCP PDU” comprises the following meaning: the security algorithm applied to the first PDCP PDU includes integrity protection.

In one embodiment, the sentence that “a first key is used for security algorithm of a first PDCP PDU” comprises the following meaning: the security algorithm applied to the first PDCP PDU is applied to a payload comprised by the first PDCP PDU.

In one embodiment, the sentence that “a first key is used for security algorithm of a first PDCP PDU” comprises the following meaning: the security algorithm applied to the first PDCP PDU is applied to a Message Authentication Code for Integrity (MAC-I) comprised by the first PDCP PDU.

In one embodiment, the sentence that “a first key is used for security algorithm of a first PDCP PDU” comprises the following meaning: the security algorithm applied to the first PDCP PDU includes enciphering, and a key used by the enciphering includes a NRPEK, the first key for generating the NRPEK.

In one subembodiment, the first node generates the NRPEK by means of the first key according to internal algorithm.

In one subembodiment, the first node generates the NRPEK by means of the first key according to standard algorithm.

In one subembodiment, the first node generates the NRPEK by selecting some bits randomly from the first key.

In one embodiment, the sentence that “a first key is used for security algorithm of a first PDCP PDU” comprises the following meaning: the security algorithm applied to the first PDCP PDU includes integrity protection, and a key used by the security protection includes a NRPIK, the first key for generating the NRPIK.

In one subembodiment, the first node generates the NRPIK by means of the first key according to internal algorithm.

In one subembodiment, the first node generates the NRPIK by means of the first key according to standard algorithm.

In one subembodiment, the first node generates the NRPIK by selecting some bits randomly from the first key.

In one embodiment, an identity of the first key is used for uniquely determining the first key.

In one embodiment, an identity of the first key maps to the first key.

In one embodiment, an identity of the first key is set up when establishing a secure connection.

In one embodiment, the first key is set up when establishing a secure connection.

### Embodiment 11

Embodiment 11 illustrates a structure block diagram of a processing device used in a first node according to one embodiment of the present application; as shown in FIG. 11. In FIG. 11, a processing device 1100 in the first node comprises a first receiver 1101 and a first transmitter 1102. In Embodiment 11,
the first transmitter 1102 transmits a first Medium Access Control (MAC) Protocol Data Unit (PDU), the first MAC PDU comprising a first MAC header and a first MAC subPDU, the first MAC subPDU comprising a first MAC sub-header and a first MAC Service Data Unit (SDU), the first MAC SDU comprising a first Packet Data Convergence Protocol (PDCP) PDU; the first PDCP PDU being a PDCP PDU of a unicast sidelink radio bearer (RB);
herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID.

In one embodiment, a header of the first PDCP PDU indicates an identity of a first key, the first key being used for the security algorithm of the first PDCP PDU.

In one embodiment, the first receiver 1101 receives a second MAC PDU before the action of transmitting a first MAC PDU, the second MAC PDU for generating the first MAC PDU;
herein, the second MAC PDU comprises a second MAC header and a second MAC subPDU, the second MAC subPDU comprising a second MAC subheader and a second MAC SDU, the second MAC SDU comprising the first PDCP PDU; the generator of the first PDCP PDU is a node other than the first node.

In one embodiment, the second MAC header comprises a first field and a second field, where the first field in the second MAC header indicates the generator of the first PDCP PDU, while the second field in the second MAC header indicates the first node; the first MAC header comprises a first field and a second field, where the first field comprised by the first MAC header indicates the first node, while the second field comprised by the first MAC header indicates a receiver of the first MAC PDU.

In one embodiment, the first MAC SDU comprises a PDU of a first protocol layer, the first protocol layer being a protocol layer between an RLC layer and a PDCP layer, with a header of the PDU of the first protocol layer comprising the target parameter;
herein, the generator of the first PDCP PDU is a node other than the first node.

In one embodiment, the target parameter is a state variable of a second protocol layer, the second protocol layer being one of a MAC layer, a Radio Link Control (RLC) layer, a PDCP layer or a first protocol layer;
herein, the first protocol layer is a protocol layer between the RLC layer and the PDCP layer.

In one embodiment, the target parameter is used for identifying a link or a node.

In one embodiment, the first transmitter 1102 transmits a third MAC PDU, the third MAC PDU comprising a third MAC header and a third MAC subPDU, the third MAC subPDU comprising a third MAC subheader and a third MAC SDU, the third MAC SDU comprising a first signaling, the first signaling used for indicating the target parameter;
herein, the third MAC header comprises a first field and a second field, where the first field in the third MAC header indicates the first node, while the second field in the third MAC header indicates one of a generator of the first PDCP PDU or a receiver of the first MAC PDU.

In one embodiment, the first receiver 1101 receives a fourth MAC PDU; the fourth MAC PDU comprises a fourth MAC header and a fourth MAC subPDU, the fourth MAC subPCU comprising a fourth MAC subheader and a fourth MAC SDU, the fourth MAC SDU comprising a second PDCP PDU; the second PDCP PDU being a PDCP PDU of a unicast sidelink RB; the target parameter is used for security algorithm of the second PDCP PDU;
herein, the fourth MAC header comprises a first field and a second field, where the first field in the fourth MAC header indicates a receiver of the first MAC PDU; while the second field in the fourth MAC header indicates the first node.

In one embodiment, a change of the target parameter is used for triggering re-establishment of a PDCP entity that generates the first PDCP PDU.

In one embodiment, the first node is a UE.

In one embodiment, the first node is a terminal supporting large delay difference.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2U remote UE.

In one embodiment, the first node is an IoT terminal or IIoT terminal.

In one embodiment, the first node is a piece of equipment supporting transmissions with low delay and high reliability.

In one embodiment, the first node is a sidelink communication node.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

### Embodiment 12

Embodiment 12 illustrates a structure block diagram of a processing device used in a first node according to one embodiment of the present application; as shown in FIG. 12. In FIG. 12, a processing device 1200 in a first node is comprised of a first receiver 1201 and a first transmitter 1202. In Embodiment 12,
the first transmitter 1202 transmits a first Medium Access Control (MAC) Protocol Data Unit (PDU), the first MAC PDU comprising a first MAC header and a first MAC subPDU, the first MAC subPDU comprising a first MAC sub-header and a first MAC Service Data Unit (SDU), the first MAC SDU comprising a first Packet Data Convergence Protocol (PDCP) PDU;
herein, a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is a first state variable of a PDCP layer; PDCP entities for generating and receiving the first PDCP PDU are respectively maintained by 2 UEs.

In one embodiment, the first PDCP PDU is a PDCP PDU of a unicast sidelink radio bearer (RB).

In one embodiment, a name of the first state variable is COUNT.

In one embodiment, a header of the first PDCP PDU indicates an identity of a first key, the first key being used for the security algorithm of the first PDCP PDU.

In one embodiment, the sentence that a target parameter is used for security algorithm of the first PDCP PDU means that: 5 least significant bits (LSB) of the target parameter are used for an input to the security algorithm of the first PDCP PDU.

In one embodiment, the first receiver 1201 receives a second MAC PDU before the action of transmitting a first MAC PDU, the second MAC PDU for generating the first MAC PDU;
herein, the second MAC PDU comprises a second MAC header and a second MAC subPDU, the second MAC subPDU comprising a second MAC subheader and a second MAC SDU, the second MAC SDU comprising the first PDCP PDU; the generator of the first PDCP PDU is a node other than the first node.

In one embodiment, the second MAC header comprises a first field and a second field, where the first field in the second MAC header indicates the generator of the first PDCP PDU, while the second field in the second MAC header indicates the first node; the first MAC header comprises a first field and a second field, where the first field comprised by the first MAC header indicates the first node, while the second field comprised by the first MAC header indicates a receiver of the first MAC PDU.

In one embodiment, the first MAC SDU comprises a PDU of a first protocol layer, the first protocol layer being a protocol layer between an RLC layer and a PDCP layer, with a header of the PDU of the first protocol layer comprising the target parameter;
herein, the generator of the first PDCP PDU is a node other than the first node.

In one embodiment, the first transmitter 1202 transmits a third MAC PDU, the third MAC PDU comprising a third MAC header and a third MAC subPDU, the third MAC subPDU comprising a third MAC subheader and a third MAC SDU, the third MAC SDU comprising a first signaling, the first signaling used for indicating the target parameter;
herein, the third MAC header comprises a first field and a second field, where the first field in the third MAC header indicates the first node, while the second field in the third MAC header indicates one of a generator of the first PDCP PDU or a receiver of the first MAC PDU.

In one embodiment, the first receiver 1201 receives a fourth MAC PDU; the fourth MAC PDU comprises a fourth MAC header and a fourth MAC subPDU, the fourth MAC subPCU comprising a fourth MAC subheader and a fourth MAC SDU, the fourth MAC SDU comprising a second PDCP PDU; the second PDCP PDU being a PDCP PDU of a unicast sidelink RB; the target parameter is used for security algorithm of the second PDCP PDU;
herein, the fourth MAC header comprises a first field and a second field, where the first field in the fourth MAC header indicates a receiver of the first MAC PDU; while the second field in the fourth MAC header indicates the first node.

In one embodiment, a change of the target parameter is used for triggering re-establishment of a PDCP entity for generating the first PDCP PDU.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transmitter, transmitting a first Medium Access Control (MAC) Protocol Data Unit (PDU), the first MAC PDU comprising a first MAC header and a first MAC subPDU, the first MAC subPDU comprising a first MAC sub-header and a first MAC Service Data Unit (SDU), the first MAC SDU comprising a first Packet Data Convergence Protocol (PDCP) PDU; the first PDCP PDU being a PDCP PDU of a unicast sidelink radio bearer (RB);
wherein a target parameter is used for security algorithm of the first PDCP PDU; whether the target parameter is a logical channel identity (LCID) is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU.

2. The first node according to claim 1, characterized in comprising:
a first receiver, receiving a second MAC PDU before the action of transmitting a first MAC PDU, the second MAC PDU for generating the first MAC PDU;
wherein the second MAC PDU comprises a second MAC header and a second MAC subPDU, the second MAC subPDU comprising a second MAC subheader and a second MAC SDU, the second MAC SDU comprising the first PDCP PDU; the generator of the first PDCP PDU is a node other than the first node.

3. The first node according to claim 2, characterized in that
the second MAC header comprises a first field and a second field, where the first field in the second MAC header indicates the generator of the first PDCP PDU, while the second field in the second MAC header indicates the first node; the first MAC header comprises a first field and a second field, where the first field comprised by the first MAC header indicates the first node, while the second field comprised by the first MAC header indicates a receiver of the first MAC PDU.

4. The first node according to claim 1, characterized in that
the first MAC SDU comprises a PDU of a first protocol layer, the first protocol layer being a protocol layer between an RLC layer and a PDCP layer, with a header of the PDU of the first protocol layer comprising the target parameter;
wherein the generator of the first PDCP PDU is a node other than the first node.

5. The first node according to claim 2, characterized in that
the first MAC SDU comprises a PDU of a first protocol layer, the first protocol layer being a protocol layer between an RLC layer and a PDCP layer, with a header of the PDU of the first protocol layer comprising the target parameter;
wherein the generator of the first PDCP PDU is a node other than the first node.

6. The first node according to claim 3, characterized in that
the first MAC SDU comprises a PDU of a first protocol layer, the first protocol layer being a protocol layer between an RLC layer and a PDCP layer, with a header of the PDU of the first protocol layer comprising the target parameter;
wherein the generator of the first PDCP PDU is a node other than the first node.

7. The first node according to claim 1, characterized in that
the target parameter is a peer-to-peer identity or identifier;
wherein the first node is not a generator of the first PDCP PDU.

8. The first node according to claim 4, characterized in that
the target parameter is a BEARER ID.

9. The first node according to claim 5, characterized in that
the target parameter is a BEARER ID.

10. The first node according to claim 6, characterized in that
the target parameter is a BEARER ID.

11. The first node according to claim 4, characterized in that
the target parameter is an identity of a radio bearer between the generator of the first PDCP PDU and a receiver of the first MAC PDU.

12. The first node according to claim 5, characterized in that
the target parameter is an identity of a radio bearer between the generator of the first PDCP PDU and a receiver of the first MAC PDU.

13. The first node according to claim 6, characterized in that
the target parameter is an identity of a radio bearer between the generator of the first PDCP PDU and a receiver of the first MAC PDU.

14. The first node according to claim 8, characterized in that
5 bits of the target parameter are as inputs of parameters of the security algorithm from BEARER[0] to BEARER[4].

15. The first node according to claim 11, characterized in that
5 bits of the target parameter are as inputs of parameters of the security algorithm from BEARER[0] to BEARER[4].

16. The first node according to claim 1, characterized in that
when the first node is not the generator of the first PDCP PDU, the first node is a L2 U2U (i.e., UE to UE) relay node.

17. The first node according to claim 8, characterized in that
when the first node is not the generator of the first PDCP PDU, the first node is a L2 U2U relay node.

18. The first node according to claim 11, characterized in that
when the first node is not the generator of the first PDCP PDU, the first node is a L2 U2U relay node.

19. The first node according to claim 1, characterized in that
when the first node is the generator of the first PDCP PDU, the first node is not a L2 U2U relay node; the first node is a remote UE.

20. A method in a first node for wireless communications, comprising:
transmitting a first MAC PDU, the first MAC PDU comprising a first MAC header and a first MAC subPDU, the first MAC subPDU comprising a first MAC sub-header and a first MAC SDU, the first MAC SDU comprising a first PDCP PDU; the first PDCP PDU being a PDCP PDU of a unicast sidelink RB;
wherein a target parameter is used for security algorithm of the first PDCP PDU; whether the target parameter is a LCID is related to whether the first node is a generator of the first PDCP PDU; when the first node is the generator of the first PDCP PDU, the target parameter is a LCID; when the first node is not the generator of the first PDCP PDU, the target parameter is not a LCID; a header of the first PDCP PDU indicates an identity of a first key, the first key being used for the security algorithm of the first PDCP PDU.
